(19) United States
(12) Patent Application Publication
(10) Pub. No.: US 2007/0197202 A1
(43) Pub. Date: Aug. 23, 2007

(54) System and method for application auto-disable/restore enhancement

(76) Inventors: Stephen A. Sprigg, Poway, CA (US); Marc Edward Nijdam, San Diego, CA (US); Jun Yamada, Konan-Ku (JP); Jason B. Kenagy, San Diego, CA (US)

Correspondence Address: QUALCOMM INCORPORATED, 5775 MOREHOUSE DR., SAN DIEGO, CA, 92121, US

(21) Appl. No.: 11/357,283

(22) Filed: Feb. 17, 2006

(51) Int. Cl. H04M 3/00

(52) U.S. Cl. 455/418

(57) ABSTRACT

A system and method for managing the deleting and reloading of software application components on a wireless device, such as a cellular telephone, personal digital assistant, pager, or other computer platform. The wireless device has one or more resident executable software applications wherein each application has one or more application components and application-associated data, such as software licenses and user-specific data. The wireless device selectively deletes one or more application components of the resident software applications without loss of the application-associated data to clear resources on the wireless device, and selectively prompts a backup device coupled to a wireless network to transmit deleted application components that need to be reinstalled on the wireless device to execute the application.

### BACKGROUND OF THE INVENTION

I. Field

The present invention generally relates to data networks and computer communications across the data networks. More particularly, the invention relates to the installation and deletion of software applications and their components on wireless devices in selective communication with one or more other devices across a wireless data network.

II. Background

Advances in technology have resulted in smaller and more powerful personal computing devices. For example, there currently exist a variety of portable personal computing devices, including laptops, wireless computing devices, such as portable wireless telephones, personal digital assistants (PDAs) and paging devices that are each small, lightweight, and can be easily carried by users. A wireless device is any device that can communicate with other devices without being physically attached to them. Most wireless devices communicate with each other through radio frequencies.

Wireless devices, such as cellular telephones, communicate packets including voice and data over a wireless network. Cellular telephones themselves are being manufactured with increased computing capabilities and are becoming tantamount to personal computers and hand-held personal digital assistants (“PDAs”). Some of the personal computing devices utilize an application programming interface (API) or application programming interfaces (APIs), sometimes referred to as runtime environments and software platforms, that are installed onto their local computer platform and which are used, for example, to simplify operations of such devices, such as by providing generalized calls for device specific resources. Generally, an API can be considered a set of routines used by an application program to direct the performance of procedures by the computer's operating system.

These “smart” cellular telephones have installed application programming interfaces (“APls”) onto their local computer platform that allow software developers to create software applications (commonly referred to as “programs”) that are fully executable on wireless devices. The API sits between the wireless device system software and the software application making the cellular telephone computing functionality available to the application without requiring the software developer to have the specific cellular telephone system source code. Further, some APIs are known to provide mechanisms for secure communications between such personal devices (i.e., clients) and remote devices (i.e., servers) using secure cryptographic information and communication techniques.

Examples of such APIs, some of which are discussed in more detail below, include versions of the Binary Runtime Environment for Wireless software (BREW®) developed by QUALCOMM, Inc., of San Diego, Calif. BREW® can cooperate with a computing device's (e.g., a wireless cellular phone) operating system, and can, among other features, provide interfaces to hardware features that are particularly found on personal computing devices. BREW® can also provide these interfaces on such personal computing devices at a relatively low cost with respect to demands on device resources and with respect to the price paid by consumers for devices containing BREW®. Additional features of BREW® include its end-to-end software distribution platform that provides a variety of benefits for wireless service operators, software developers and computing device consumers. At least one such currently available end-to-end software distribution platform includes logic distributed over a server-client architecture, where the server performs, for example, billing, security and application distribution functionality, and the client performs, for example, application execution, security and user interface functionality.

The foregoing description of the related art is merely intended to provide an overview of some of the known uses of APIs and as an introduction to the BREW® platform, which can be used in embodiments of the invention. However, the invention is not to be construed as being limited to a specific implementation, operating platform or environment.

The software applications can come pre-loaded at the time the wireless telephone is manufactured, or the user may later request that additional programs be downloaded over cellular telecommunication carrier networks, where the downloaded applications are executable on the wireless telephone. As a result, users of wireless telephones can customize their wireless telephones through the selective downloading of applications, such as games, printed media, stock updates, news, or any other type of information or application that is available for download through the wireless network. In order to manage the cellular telephone resources and applications, the user of the wireless telephone purposefully deletes applications and data from the wireless telephone platform to clear storage space so that new applications can be loaded onto the cleared storage.

In contrast to the larger computer platforms of personal computers and PDAs, wireless devices have limited resources, such as storage and processing, to devote to non-essential applications. Typically, the telecommunication applications have priority of usage of the system resources, with other applications allocated resources as available. The wireless device thus only has a limited capacity for holding all files for applications, and the managing of resources is left up to the discretion of user of the telephone to delete applications to make room for new applications desired downloaded to the wireless device. The wireless device will not otherwise download an application that it does not have the resources to hold and execute.

In seeking to free resources on the wireless device, the user normally cannot remove certain components of a resident application without disabling the entire resident application. If the user sought to delete specific components, such action would controvert the intended freeing of resources as the disabled resident application cannot be restored without full reinstallation of the application. The useless undeleted application components still needlessly take up storage space even though the main application is unexecutable. This all-or-nothing deletion requirement for the resident software applications on the wireless device greatly limits the number of applications that can be resident on the wireless device and available to the user.

Accordingly it would be advantageous to provide a wireless device that can remove certain components of applications while maintaining important data for the application, such as licenses and user-specific data, to maximize the utilization of computer resources on the wireless device. Upon the wireless device requiring the deleted software components to again execute the application, the wireless device can obtain the software components through the wireless network. It is thus to the provision of such a system and method that can control the deletion and reloading of select software application components at the wireless device that the present invention is primarily directed.

### SUMMARY OF THE INVENTION

The present invention is a system and method for managing the loading and deletion of software application components on a wireless device, such as a cellular telephone, personal digital assistant, pager, or other computer platform. The wireless device has one or more resident executable software applications wherein each application includes one or more application components and application-associated data, such as software licenses and user-specific data, and the wireless device is in selective communication with a wireless network. There is at least one backup device on the wireless network that selectively communicates,with wireless devices and downloads software applications and application components to the wireless devices.

To manage system resources, and especially storage space, the wireless device selectively deletes one or more application components of the one or more resident software applications without loss of the application-associated data, and then selectively prompts the backup device across the wireless network for transmission of one or more application components when the application is again desired to be executed on the wireless device. Once the one or more application components are received from the backup device, the wireless device installs the one or more application components for resident applications with components previously deleted such that the resident applications are again executable on the wireless device.

The application-associated data is data that is typically not recoverable should it be deleted. Examples of the application-associated date can be data required to execute the software application, such as a license, or could be user-specific data such as personal identification data, high scores for games, an address book, or the like, with or without the license. The application-associated data can also include application components necessary to execute the application on the wireless device such as a specific driver or application-critical module.

The method for managing the loading and removal of components of one or more software applications resident on a wireless device accordingly includes the steps of selectively deleting at the wireless device one or more application components of the one or more resident software applications without loss of the application-associated data, selectively establishing a communication link from the wireless device to a backup device wherein the wireless device prompts the backup device for transmission of one or more deleted application components, and installs the transmitted one or more application components such that the one or more resident-applications including the installed application components are executable on the wireless device.

The method of establishing a communication link is preferably establishing a communication link through a cellular telecommunication network, especially if the wireless device is a cellular telephone or pager. The establishing of a communication link typically occurs upon the wireless device intending to execute a resident software application for which one or more associated components have been deleted, and wireless device can prompt the user to make a communication link to the backup device to retrieve a copy of the deleted component, if necessary.

The method of selectively deleting at the wireless device one or more application components of the one or more resident software applications may occur at the direction of the user of the wireless device when the user desires to clear resources to download a new software application that will require the resources. However, the deletion can also occur as determined by the wireless device managing its resources in accord with the actions of the user seeking to download applications which requires the freeing of system resources.

The present invention also includes a wireless device itself that can function in the inventive system, and a program in a computer readable medium that directs a wireless device having a computer platform to perform the steps of the inventive method.

A system and method allows a wireless device to delete certain components of its resident software applications while maintaining related data for the applications, such as licenses and user-specific data, to maximize the utilization of computer resources, such as storage. The wireless device can still execute the software application for which components have been deleted by retrieving copies of the deleted software components through the wireless network from the backup device. This permits the efficient usage of the wireless device system resources such that the user can have ready access to a larger amount of executable software applications than can be completely stored on the wireless device. While the component deletion and reloading processes can be at the direction of the user, the processes can also be fully automated on the wireless device such that the processes are transparent to the user.

Other advantages, and features of the present invention will become apparent after review of the hereinafter set forth Brief Description of the Drawings, Detailed Description of the Invention, and the Claims.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a representative diagram of a system for managing the temporary deletion and reloading of software application components on wireless devices in selective communication with one or more application download servers over a wireless network;

FIG. 2 is a block diagram of the hardware components of an exemplary wireless network providing communication between different wireless devices and an application download server and database;

FIG. 3 is a file table resident on the wireless device platform specifically illustrating an application with its constituent components;

FIG. 4 is a flowchart illustrating the selective deletion of application components on the wireless device;

FIG. 5 is a flowchart illustrating the retrieval of the wireless device of application components from the application download server to restore an application on the wireless device such that the application is again executable; and

FIG. 6 is a flowchart illustrating the retrieval of the wireless device of application components from a backup device to restore and application on the wireless device such that the application is again executable.

### DETAILED DESCRIPTION OF THE INVENTION

Embodiments of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

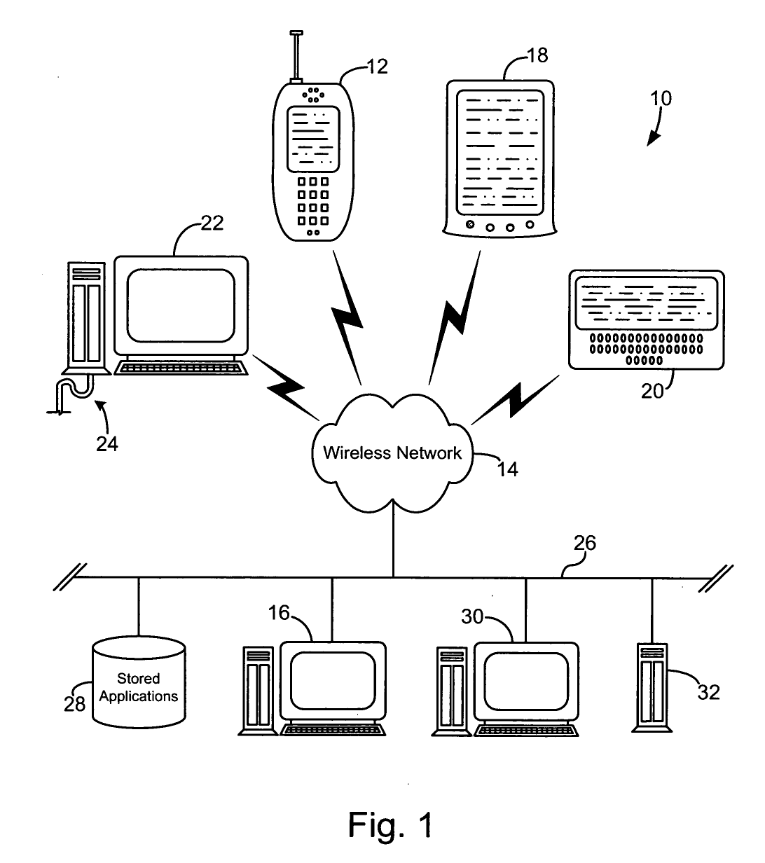

FIG. 1 illustrates a representative system 10 for the deletion and reloading of software application components on a wireless device, such as cellular telephone 12, in communication across a wireless network 14 with at least one application download server 16 that selectively transmits software applications and components to wireless devices across a wireless communication portal or other data access to the wireless network 14. As shown here, the wireless device can be a cellular telephone 12, a personal digital assistant 18, a pager 20, which is shown here as a two-way text pager, or even a separate computer platform 22 that has a wireless communication portal, and may otherwise have a wired connection 24 to a network or the Internet. The inventive system can thus be performed on any form of remote module including a wireless communication portal, including without limitation, wireless modems, PCMCIA cards, access terminals, personal computers, access terminals, telephones without a display or keypad, or any combination or sub-combination thereof.

The application download server 16 is shown here on a network 26 with other computer elements in communication with the wireless network 14. There is a second server 30 and a stand-alone server 32, and each server can provide separate services and processes to the wireless devices 12,18,20,22 across the wireless network 14. There is preferably also at least one stored application database 28 that holds the applications that are downloadable by the wireless devices 12,18,20,22.

Other devices may be used to perform the same functions as those of the application download server 16. For example, a backup device (not shown) may also perform the same functions as those performed by the application download server as previously and subsequently discussed. FIG. 6 will discuss one of these embodiments later on.

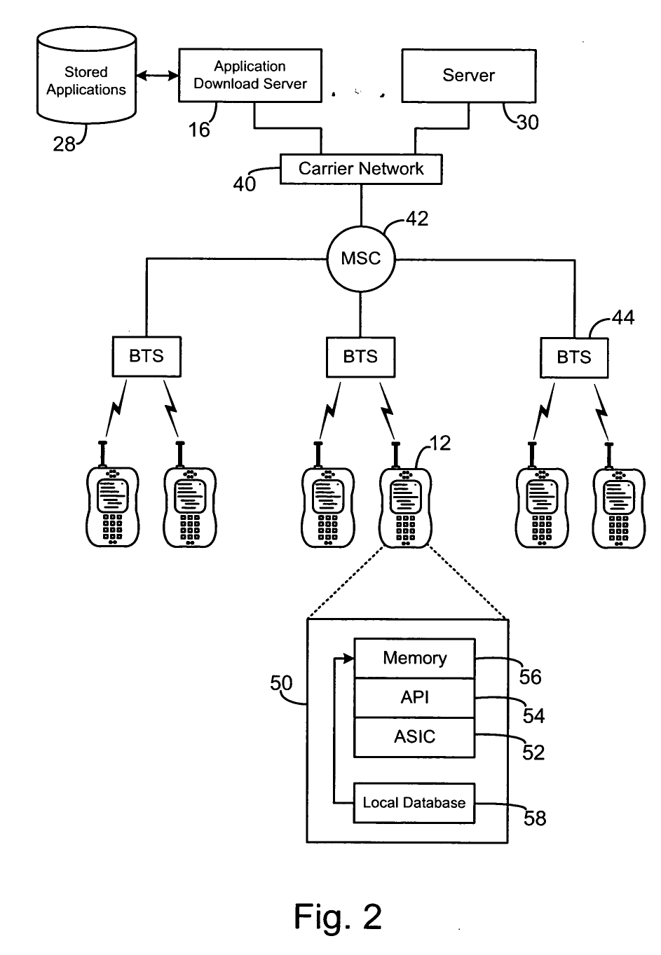

In FIG. 2, a block diagram is shown that more fully illustrates the components of the wireless network 14 and interrelation of the elements of the present invention. The wireless network 14 is merely exemplary and can include any system whereby remote modules, such as wireless devices 12,18,20,22 communicate over-the-air between and among each other and/or between and among components of a wireless network 14, including, without limitation, wireless network carriers and/or servers. The application download server 16 and the stored application database 28, along any other servers such as server 30 which are needed to provide cellular telecommunication services, communicate with a carrier network 40, through a data link, such as the Internet, a secure LAN, WAN, or other network. The carrier network 40 controls messages (sent as data packets) sent to a messaging service controller (“MSC”) 42. The carrier network 40 communicates with the MSC 42 by a network, the Internet and/or POTS (“plain ordinary telephone system”). Typically, the network or Internet connection between the carrier network 40 and the MSC 42 transfers data, and the POTS transfers voice information. The MSC 42 is connected to multiple base stations (“BTS”) 44. In a similar manner to the carrier network, the MSC 42 is typically connected to the BTS 44 by both the network and/or Internet for data transfer and POTS for voice information. The BTS 44 ultimately broadcasts messages wirelessly to the wireless devices, such as cellular telephone 12, by short messaging service (“SMS”), or other over-the-air methods known in the art.

The wireless device, such as cellular telephone 12, has a computer platform 50 that can receive and execute software applications transmitted from the application download server 16. The computer platform 50 includes an application-specific integrated circuit (“ASIC” 52), or other processor, microprocessor, logic circuit, or other data processing device. The ASIC 52 is installed at the time of manufacture of the wireless device and is not normally upgradeable. The ASIC 52 or other processor executes the application programming interface (“API”) layer that interfaces with any resident programs in the memory 56 of the wireless device. The memory comprises read-only or random-access memory (RAM and ROM), EPROM, flash cards, or any memory common to computer platforms. The computer platform 50 also includes a local database 58 that can hold applications not actively used in memory 56. The local database 58 is typically a flash memory cell, but can be any secondary storage device as known in the art, such as magnetic media, EPROM, optical media, tape, or soft or hard disk.

The wireless device, such as cellular telephone 12, accordingly downloads one or more software applications, such as games, news, stock monitors, and the like, and holds the application on the local database 58 when not in use, and uploads stored resident applications on the local database 58 to memory 56 for. execution on the API 54 when so desired by the user. However, there are significant cost and size constraints on the wireless device that limit the installed storage capability available in the local database 58 and memory 56, so a limited amount of resident software applications can be held on the wireless device. The present inventive system and method manages this limitation of storage capacity through the selective deletion and reloading of individual software application components, as is further described herein.

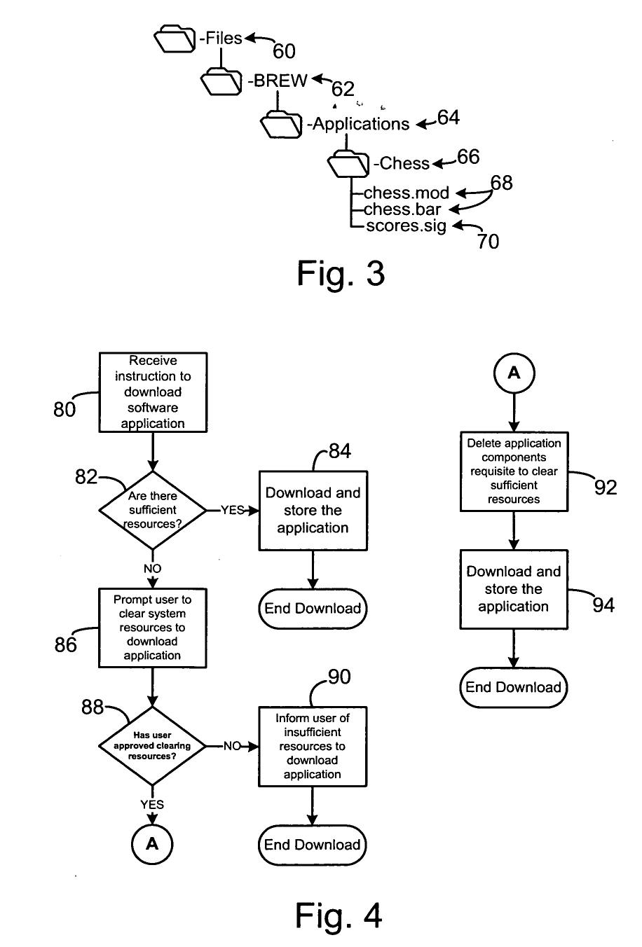

With reference to FIG. 3, there is shown an illustrative file structure, or data management structure, held in the API 54. The top-level domain is “Files” 60 that contains all of the discrete software files on the computer platform 50. The file structure of FIG. 3 is merely illustrative and may not appear in this form on the computer platform 50, and may even be present purely in machine code on the wireless device 12,18,20,22 with no discernable file structure. In the Files 60 is the API, which here is shown as binary runtime environment for windows (“BREW”) 62, which is the API used by QUALCOMM® to interact with software applications on the wireless device computer platform 50. The BREW 62 files include application files 64, and one file is game of chess 66 that has been downloaded from the application download server 16 and is now resident on the local database 58 of the computer platform 50 of the wireless device. For purposes of illustration, the chess 66 application is a resident software application of the wireless device.

The chess 66 application includes several software components 68, such as the files chess.mod and chess.bar. The application components 68 are necessary modules to execute the chess application on the computer platform 50. Chess 66 also includes specific application-associated data, shown here as a scores.sig 70, which are the stored scores for the user playing games of chess on the computer platform 50. There also can be a license included as a hidden file in the chess 66 application. Thus, the application components 68 that allow execution of the game of chess are easily duplicated with a copy transmitted from the application download server 16, while the associated-application data, such as the scores 70 and the license will be lost if their files or modules are deleted. The present invention therefore utilizes the ability to obtain another copy of the non-essential application components from the application download server 16 while maintaining the non-retrievable application-associated data, such as a license, or user specific data, such as personal information and addresses, or even purely entertainment-related data such as the previous scores 70 for chess games.

When the user desires to download another software application to the computer platform 50 and there are insufficient resources, especially in terms of storage on the local database 58, the BREW API 62, or other space-managing components, can trigger a prompt to the user to ask if the application components for chess can be removed so that the requested downloaded application can be placed on the computer platform 50. Otherwise, the BREW API 62 can determine which components to delete and automatically manages the system resources. While the chess.mod and chess.bar files are deleted from the chess 66 file, the chess game will not be executable on the computer platform 50. Through the separation of essential and non-essential files on the computer platform 50, the wireless device can selectively delete one or more of the application components 68 of the one or more resident software applications without loss of the application-associated data, such as the scores file 70.

When the application which has had one or more application components deleted, such as the chess game 66 with the chess.mod and the chess.bar application components 68 deleted and the user desires to again use that application, the wireless device will selectively prompts the application download server 16 across the wireless network 14 for transmission of one or more application components 68. Once the wireless device receives the application components 68, the wireless device installs the transmitted one or more application components 68 back onto the computer platform 50 such that the resident application, or here chess 66, is again executable. It should be noted that all of the application components 68 do not have to be removed, and can be deleted based upon size of the application or other criteria. Further, the files containing application-associated data, such as scores.sig 70, can also contain application components required to execute the application and are not necessarily pure data-containers.

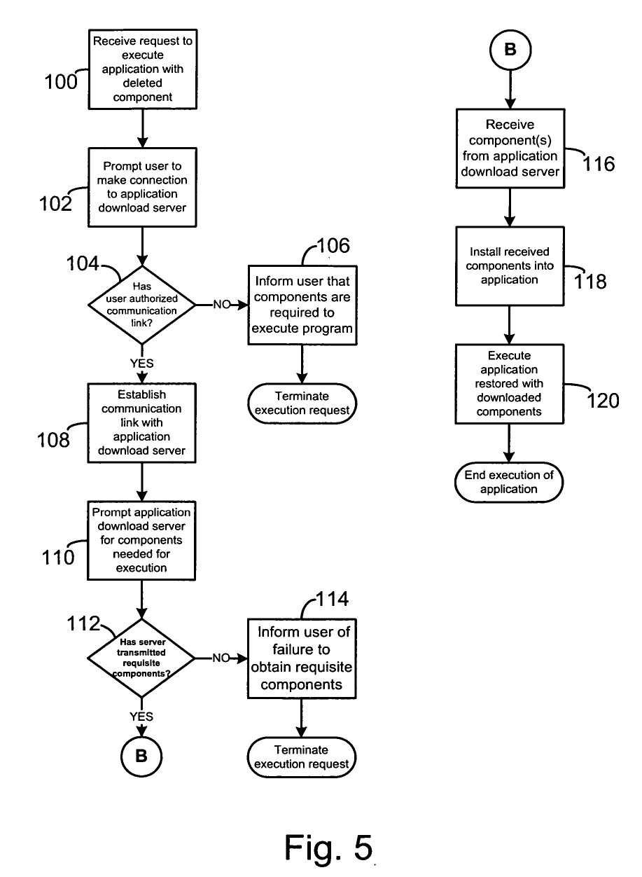

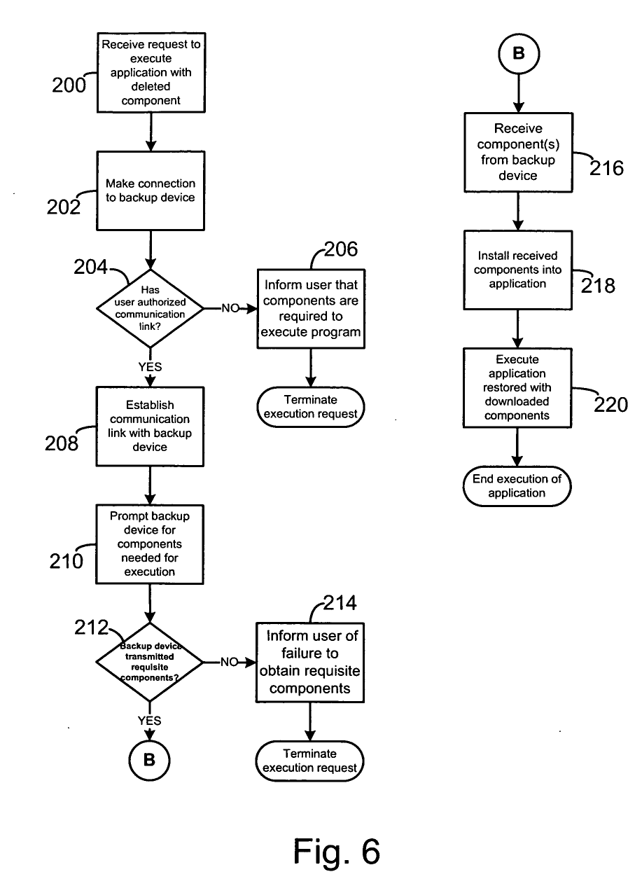

FIGS. 4 and 5 are flowcharts illustrating the inventive method for managing the loading and removal of application components 68 of one or more software applications resident on the computer platform 50 of a wireless device 12,18,20,22. As shown in FIG. 4, the computer platform 50 receives the instruction to download a software application, shown at step 80, and then a decision is made on the ASIC 52 or other processor of the wireless device as to whether there are sufficient resources available to download the application, as shown at decision 82. If there are sufficient resources available, then the application is downloaded and stored, as shown at step 84, and the download process is terminated. If there are insufficient resources at decision 82, then the user is prompted to clear system resources in order to download the application, as shown at step 86, which entail the deleting of certain application components. A decision is then made as to whether the user approves of clearing resources, as shown at decision 88, and if not, the user is informed of the insufficient resources available for the download, as shown at step 90, and the download process is terminated. If the user approves of clearing resources at decision 88, then one or more application components, such as components 68, are selectively deleted to clear the requisite resources, and such deletion occurs without significant loss of the application-associated data, such as the scores.sig file 70 or any license to use the application. Then the application is downloaded and stored on the computer platform 50, as shown at step 94, and the down load process is terminated.

The process to reinstall the deleted components is shown in FIG. 5 when a request to execute the application with one or more deleted components 68 is received, as shown at step 100. An example of this would be the user seeking to play the chess game once again. The user is then preferably prompted to make a communication link to the application download server 16, as shown by step 102. However, the wireless device at receipt of the execution request can alternately automatically establish the communication link. If a request to execute the application is requested of the user, then a decision is made as to whether the user has authorized the link, as shown at decision 104. If the user declines establishing the link, the user is informed that the needed application components must be downloaded in order to execute the request application, as shown at step 106, and then the execution request is terminated. If the user authorizes the communication link at decision 104, then a communication link is establish with the application download server 16, as shown at step 108.

Once the communication link is established with the application download server 16, the application download server 16 is prompted by the wireless device to transmit one or more application components that are needed by the wireless device to execute the requested application, as shown at step 110. It is then determined if the server transmitted requisite application components, as shown at decision 112, and if not, the user is informed of the failure to obtain the requisite components, as shown at step 114, and the execution request is terminated. Otherwise, if the server has transmitted the requisite components at decision 112, the wireless device receives the components form the application download server, as shown at step 116, and installs the received components into the application such that the application is executable, as shown at step 118. The application is then executed on the wireless device until terminated, as shown at step 120.

If the reloading of the deleted application components, such as application components 68, were automatic, the process of FIG. 5 would go right from the receipt of the request to execute the application at step 100 to prompting the application download server 16 at step 110. The wireless device would only inform the user if the application failed to download the components, as shown at step 114.

The step of establishing a communication link is typically establishing a communication link through a digital or analog cellular telecommunication network as shown in FIG. 2, but other wireless networks such as a wireless LAN, or a microwave or infrared network can alternately be used. Further, establishing a communication link can occur automatically upon the wireless device 12,18,20,22 intending to execute a resident software application for which one or more associated components have been deleted, i.e. the wireless device bridges a communication through the wireless network 14 to the application download server 16. Otherwise, the step of establishing a communication link can occur upon the specific prompt of user of the wireless device 12,18,20,22 to bridge a communication link the application download server 16 to transmit over the wireless network 14 one or more application components for a resident software application for which one or more associated components have been deleted. If the user of the wireless device will be billed for the communication link, such as a cellular phone call, in order to have the new application components transmitted to the wireless device, then the user should be prompted prior to deletion of the component(s) to authorize the communication link that will be necessarily to reload the components. The user can again be prompted when the communication link is needed to retrieve the components of the application to render the application executable. However, if the wireless device is fully automated and the communication link does not necessitate a Gharge to the user, then no prompt needs to be made to the user, and the reloading of the component(s) is transparent, unless a problem is encountered and an error message generated, such as at step 114.

In another embodiment shown in FIG. 6, a process to reinstall the deleted components from a backup device (not shown) is illustrated. Those skilled in the art will appreciate that a backup device is any device that is capable of providing a backup or a duplicate or copy of a program or data or any portion or combination of the program or data. Step 200 shows when a request to execute the application with one or more deleted components is received. In contrast to the embodiment described in FIG. 5, the embodiment described in FIG. 6 will disable and restore applications to and from a device (or devices) that has been installed and specified as a backup device. This allows applications to be seamlessly disabled to a backup device connected to another device (e.g. a wireless phone) and the applications are restored without downloading the applications from an application download server.

An API (e.g. BREW) determines if a backup device is attached. If a positive determination is made that a backup device is attached, a connection is made to the backup device in step 202. This connection can be made by the user or alternatively, the connection can be automatically established. If a request to execute the application is requested of the user, then a decision is made is made as to whether the user has authorized the link, as shown in decision 204. If the user declines establishing the link, the user is informed that the needed application components must be downloaded in order to execute the request application, as shown at step 206, and then the execution request is terminated. If the user authorizes the communication link at decision 204, then a communication link is established with a backup device as shown at step 208.

Once the communication link is established with the backup device, the backup device is prompted by the wireless device to transmit one or more application components that are needed by the wireless device to execute the requested application, as shown in step 210. It is then determined if the backup device transmitted requisite application components, as shown at decision 212, and if not, the user is informed of the failure to obtain the requisite components, as shown at step 214, and the execution request is terminated.

Otherwise, if the backup device has transmitted the requisite components at decision 212, the wireless device receives the components from the backup device, as shown in step 216, and installs the received components, into the application such that the application is executable, as shown in step 218. The application is then executed on the wireless device until terminated, as shown in step 220.

If the reloading of the deleted application components, such as application components 68, were automatic, the process of FIG. 6 would go right from the receipt of the request to execute the application at step 200 to prompting a backup device at step 210.

In one exemplary scenario, if the backup device is attached and the applicable files are there, the backup device copies them back to the wireless device. If the files are not located on the backup device, the backup device is not present, or the backup device is present and cannot be located, then the files can be retrieved and downloaded from an application server coupled to the wireless network.

This allows an application to be seamlessly disabled to a backup device connected to a phone and restored without downloading applications over the air (OTA) via an applications server [e.g. Brew® Distribution Server (BDS)]. For example, a user selects an application on the wireless device that they want to disable. This selection can be either manual or automatic. The system then determines if a backup device is attached. The discussion will focus on a BREW based implementation, although those skilled in the art will appreciate that other APIs may be used without departing from the spirit and scope of the present invention.

In a BREW based system, BREW will determine the presence of the backup device. If a determination is made that the backup device is present, then BREW copies the files to the backup device. These files would be the same files or a subset of the files that would have been deleted from the wireless device and whose restoration will enable the application to run it its entirety.

In another example, an application is selected to run. BREW observes that many of the application's files have been removed. BREW then determines if a backup device is attached. If the backup device is attached and the files are located on the backup device, then the files are copied back to the wireless device. In the alternative, if the files are not there or the device is not present, the files are retrieved from the application server (e.g BDS).

In view of the inventive method, the present invention includes a program resident in a computer readable medium, where the program directs a wireless device having a computer platform to perform the inventive steps of the method. The computer readable medium can be the memory 56 of the computer platform 50 of the cellular telephone 12, or other wireless device, or can be in a local database, such as local database 58 of the cellular telephone 12. Further, the computer readable medium can be in a secondary storage media that is loadable onto a wireless device computer platform, such as a magnetic disk or tape, optical disk, hard disk, flash memory, or other storage media as is known in the art. In the context of FIGS. 4 and 5, the present invention methods may be implemented, for example, by operating portion(s) of the wireless network 14 to execute a sequence of machine-readable instructions. These instructions may reside in various types of signal-bearing media. This signal-bearing media may comprise, for example, RAM (not shown) accessible by, or residing within, the components of the wireless network 14. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape), paper “punch” cards, or other suitable data storage media including transmission media such as digital and analog.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

What is claimed is:

1. A system for managing software application components on a wireless device in selective communication with a wireless network, comprising:
at least one wireless device having one or more resident executable software applications wherein each software application includes one or more application components and application-associated data;
at least one application server on the wireless network, the application server selectively communicating with the at least one wireless device and downloading software applications and application components to the one or more wireless devices across the wireless network;
at least one backup device on the wireless network, the backup device selectively communicating with the at least one wireless device and downloading software applications and application components to the one or more wireless devices across the wireless network; and
at least one wireless device for selectively deleting one or more application components of the one or more resident software applications without loss of the application-associated data, selectively prompting the backup device across the wireless network for transmission of one or more application components from at least one backup device coupled to the wireless communication means and wherein the backup device restores the one or more application components and installs the transmitted one or more application components such that the one or more resident applications including the installed application components are executable on the wireless device.

2. The system of claim 1, wherein an application server transmits one or more deleted application components that were deleted from the wireless device, if the backup device does not transmit the one or more deleted application components.

3. The system of claim 1, wherein the backup device does not transmit the one or more deleted application components because there is no backup device detected in the wireless network.

4. The system of claim 1, wherein the selective deletion of the one or more application components is performed automatically.

5. The system of claim 1, wherein the selective deletion of the one or more application components is performed non-automatically.

6. The system of claim 1, wherein the application-associated data includes a license for use of the software application.

7. The system of claim 1, wherein the application-associated data includes user-specific data.

8. The system of claim 1, wherein the application-associated data includes application components necessary to execute the application on the wireless device.

9. The system of claim 1, wherein the wireless device is a cellular telephone.

10. The system of claim 1, wherein the wireless device is a personal digital assistant.

11. The system of claim 1, wherein the wireless device is a pager.

12. A system for managing the loading and deletion of software application components on a wireless communication means, comprising:
wireless communication means for selectively communicating over a wireless network, the wireless communication means having one or more resident executable software applications wherein each software application includes one or more application components and application-associated data;
application download means for selectively downloading software applications and application components to the wireless communication means across the wireless network;
backup means for selectively backing up on the wireless network, the backup means selectively communicating with at least one wireless device and downloading software applications and application components to one or more wireless devices across the wireless network; and
wireless communication means for selectively deleting one or more application components of the one or more resident software applications without loss of the application-associated data, selectively prompting the application download means across the wireless network for transmission of one or more application components from at least one backup device coupled to the wireless communication means and wherein the backup device is capable of restoring the one or more application components, and installing the transmitted one or more application components such that the one or more resident applications including the installed components are executable on the wireless communication means.

13. A method for managing the loading and deletion of components of one or more software applications resident on a wireless device, each software application including one or more application components and application-associated data, and the wireless device in selective communication with one or more application download servers over a wireless network, the method comprising the steps of:
selectively deleting at the wireless device one or more application components of the one or more resident software applications without loss of the application-associated data;
selectively establishing a communication link from the wireless device to at least one backup device wherein the wireless device prompts the at least one backup device for transmission of one or more deleted application components;
transmitting the one or more deleted application components from a backup device to the wireless device; and
installing at the wireless device the transmitted one or more application components such that the one or more resident applications including the installed application components are executable on the wireless device.

14. The method of claim 13, wherein the step of establishing a communication link is establishing a communication link through a cellular telecommunication network.

15. The method of claim 13, wherein the step of establishing a communication link occurs upon the wireless device intending to execute a resident software application for which one or more associated components have been deleted.

16. The method of claim 13, wherein the step of selectively deleting at the wireless device one or more application components of the one or more resident software applications is selectively deleting the one or more application components of the one or more resident software applications at the direction of the user of the wireless device.

17. The method of claim 16, wherein the step of establishing a communication link occurs upon a user of the wireless device prompting the application download server to transmit over the wireless network one or more application components for a resident software application for which one or more associated components have been deleted.

18. The method of claim 13, wherein the step of selectively deleting at the wireless device one or more application components of the one or more resident software applications is selectively deleting the one or more application components of the one or more resident software application is determined by the wireless device.

19. A method for managing the loading and deletion of components of one or more software applications resident on a wireless device, software application including one or more application components and application-associated data, and the wireless device in selective communication with one or more application download servers over a wireless network, the method comprising the steps of:
a deletion step for selectively deleting at the wireless device one or more application components of the one or more resident software applications without loss of the application-associated data;
a communication step for selectively establishing a communication link from the wireless device to at least one backup device wherein wireless device prompts the at least one backup device for transmission of one or more deleted application components;
a transmission step for transmitting the one or more deleted application components from the backup device to the wireless device; and
an installation step for installing at the wireless device the transmitted one or more application components such that the one or more resident applications including the installed application components are executable on the wireless device.

20. A wireless device having one or more resident software applications wherein each application includes one or more application components and application-associated data, the wireless device in selective communication over a wireless network with at least one backup device that selectively downloads software applications and application components to the wireless device, the wireless device further selectively deleting one or more application components of the one or more resident software applications without loss of the application-associated data, selectively prompting the backup device across the wireless network for transmission of one or more deleted application components, and installing the transmitted one or more application components such that the one or more resident applications including the installed components are executable on the wireless device.

21. The wireless device of claim 20, wherein the wireless device is a cellular telephone.

22. The wireless device of claim 20, wherein the wireless device is a personal digital assistant.

23. The wireless device of claim 20, wherein the wireless device is a pager.

24. In a computer readable medium, a program that directs a wireless device having a computer platform and one or more resident software applications wherein each software application includes one or more application components and application-associated data, to perform the steps of:
selectively deleting one or more application components of one or more software applications resident on the wireless device, the deletion occurring without loss of the application-associated data;
selectively establishing a communication link over a wireless network to a backup device wherein the wireless device prompts the application download server for transmission of one or more application components that were deleted from a resident application; and
installing at the wireless device the transmitted one or more application components such that the one or more resident applications including the installed application components are executable on the wireless device.
